(19) United States
(12) Patent Application Publication
(10) Pub. No.: US 2006/0244892 A1
(43) Pub. Date: Nov. 2, 2006

(54) Liquid crystal display device

(75) Inventors: Takuya Asai, Kanagawa (JP); Takahiko Watanabe, Kanagawa (JP)

Correspondence Address: YOUNG & THOMPSON, 745 SOUTH 23RD STREET, 2ND FLOOR, ARLINGTON, VA, 22202, US

(73) Assignee: NEC LCD TECHNOLOGIES, LTD, KANAGAWA (JP)

(21) Appl. No.: 11/410,945

(22) Filed: Apr. 26, 2006

(30) Foreign Application Priority Data
Apr. 27, 2005 (JP) 2005-130254

(51) Int. Cl. G02F 1/1345

(52) U.S. Cl. 349/151

(57) ABSTRACT

In a peripheral region of an active matrix substrate, disposed is a wiring pattern of control signal wirings or power supply wirings for drive ICs mounted. The wiring pattern includes a plurality of wirings. In addition, a transfer pad is provided, which supplies a common potential to a counter electrode of a counter substrate. Moreover, a common voltage wiring connected to the transfer pad is provided. Furthermore, between the plurality of wirings and the common voltage wiring, a plurality of protective transistors are connected.

### BACKGROUND OF THE INVENTION

1. Field of the Invention

The present invention relates to a liquid crystal display device, and more particularly relates to a liquid crystal display device having drive ICs mounted on an active matrix substrate.

2. Description of the Related Art

There has been known a liquid crystal display device using a COG (chip on glass) technology. A drive IC is directly mounted on the active matrix substrate and resulting the liquid crystal display to reduce the number of components around the active matrix substrate.

In addition, there has been known a liquid crystal display device using a COF (chip on film) technology. In this technology, an insulating film member, on which a drive IC is mounted, is adhered to a peripheral part of the active matrix substrate. By adopting such a structure, the number of components around the active matrix substrate can also be reduced. Thus, the compact and thin liquid crystal display device or the narrow-bezel liquid crystal display device can be realized.

In manufacturing of the active matrix substrate, thousands of wiring patterns are arranged on a large-area mother glass substrate. Thus, it is important to provide appropriate protection against electrostatic discharge (ESD) during manufacturing processes. As an electrostatic discharge protection, there have been known the following, including: an outer guard ring for short-circuiting a plurality of external connection terminals during the manufacturing processes; and an inner guard ring connected to each of a plurality of scanning lines and a plurality of data lines through electrostatic protection elements. By discharging through the outer guard ring and the inner guard ring described above, electrostatic breakdown of the scanning lines and the data lines are prevented.

For example, in the case of the liquid crystal display device using the COG technology, in addition to a structure of a normal liquid crystal display device, a plurality of drive ICs are arranged in a peripheral part of the active matrix substrate. Moreover, wiring patterns for supplying drive signals or power voltages to the drive ICs are also formed on the active matrix substrate. For the wiring patterns, it is required to provide appropriate protection against ESD, which are different from ESD protection by use of the outer guard ring and the inner guard ring.

For example, in Japanese Patent Laid-Open No. 2003-084304, there has been proposed protection method of device breakdown even if static electricity is generated in a COG mounting step. However, in such a liquid crystal display device of the background art, wiring patterns for supplying a control signal or an operating voltage for a drive IC are in a floating state during steps of manufacturing the liquid crystal display device. In the wiring patterns, electrostatic charges are caused accumulated during manufacturing process. As the result, ESD is caused between the wiring pattern and a counter electrode of a counter substrate. Thus, the wiring pattern may be broken by electrostatic discharge. Moreover, cracks may be caused in the vicinity of insulating film on a wiring by the discharge between the wiring pattern and the counter electrode of the counter substrate. Thus, an exposed wiring may be corroded over a long period of time.

### SUMMARY OF THE INVENTION

Therefore, an exemplary feature of the invention is to provide a liquid crystal display device to protect the wiring pattern being disposed in a peripheral region of an active matrix substrate and supplying a control signal and an power voltage to a drive IC from electrostatic breakdown.

Specifically, a liquid crystal display device of the present invention, comprise an active matrix substrate having a plurality of pixel electrodes formed thereon, a counter electrode formed thereon, and a liquid crystal layer is sandwiched between the active matrix substrate and the counter substrate. In the active matrix substrate, a display region, in which the plurality of pixel electrodes are formed, and a peripheral region therearound are formed. In the peripheral region, formed are: a transfer pad which applies a common potential to the counter electrode of the counter substrate; a common voltage wiring connected to the transfer pad; a wiring pattern disposed in a vicinity of the common voltage wiring; and electrostatic protection element connected between the common voltage wiring and the wiring pattern of control signal and power voltage to a driver IC.

It is preferable that the electrostatic protection element is a transistor and the transistor on a diode is a thin film transistor in which one of a source electrode and a drain electrode is connected in common with a gate electrode.

It is preferable that the wiring pattern includes a plurality of wirings arranged substantially parallel to each other on one side of the common voltage wiring, and the transistors are provided, respectively, between the common voltage wiring and each of the plurality of wirings.

It is preferable that the wiring pattern includes a plurality of wirings arranged substantially parallel to each other on both sides of the common voltage wiring, and the transistors are provided, respectively, between the common voltage wiring and each of the plurality of wirings.

It is preferable that the wiring pattern includes a first wiring facing the counter electrode of the counter substrate and a second wiring outside an area covered by the counter substrate, the first and second wirings being arranged substantially parallel to each other, the transistor is provided between the first wiring and the common voltage wiring, and no electrostatic protection element is provided between the second wiring and the common voltage wiring.

It is preferable that the first wiring and the second wiring are connected with a driver IC mounted in a COG form of COF form in the peripheral region of the active matrix substrate.

It is preferable that the electrostatic protection element is a high-resistance element and the high-resistance element is formed of a semiconductor film.

It is preferable that the semiconductor film is a resistor configured to bleed off accumulated electrostatic charges from the wiring pattern.

It is preferable that the wiring pattern includes a plurality of wirings arranged substantially parallel to each other on one side of the common voltage wiring, and the high-resistance elements are provided, respectively, between the common voltage wiring and the plurality of wirings.

It is preferable that the wiring pattern includes a plurality of wirings arranged substantially parallel to each other on both sides of the common voltage wiring, and the high-resistance elements are provided, respectively, between the common voltage wiring and the plurality of wirings.

It is preferable that the wiring pattern includes a first wiring facing the counter electrode of the counter substrate and a second wiring outside an area covered by the counter substrate, the first and second wirings being arranged substantially parallel to each other, the high-resistance element is provided between the first wiring and the common voltage wiring, and no electrostatic protection element is provided between the second wiring and the common voltage wiring.

It is preferable that the first wiring and the second wiring are connected with a driver IC mounted in a COG form of COF form in the peripheral region of the active matrix substrate.

It is preferable that the wiring pattern is one of a control signal wiring and a power supply wiring for a drive IC mounted in a COG form in the peripheral region of the active matrix substrate.

It is preferable that the wiring pattern is one of a control signal wiring and a power supply wiring for a drive IC mounted in a COF form in the peripheral region of the active matrix substrate.

It is preferable that the liquid crystal display device of the present invention further comprising a drive IC mounted in a COG form or a COF form in the peripheral region of the active matrix substrate, the wiring pattern connected to the drive IC, and the wiring pattern being one of a control signal wiring and a power supply wiring for a drive IC.

In the present invention, the common voltage wiring is connected to the transfer pad which applies the common potential to the counter electrode of the counter substrate. Electrostatic charges accumulated in the wiring patterns disposed near the common voltage wiring are allowed to flow into the common voltage wiring through the electrostatic protection element.

According to the liquid crystal display device of the present invention, the following exemplary advantages are achieved. Specifically, according to the present invention, even if electrostatic charges are accumulated in the wiring pattern disposed in the vicinity of the common voltage wiring and the wiring pattern is charged, the charges are allowed to flow into the common voltage wiring through the electrostatic protection element. Thus, it is possible to suppress electrostatic breakdown of the wiring pattern disposed in the peripheral region of the active matrix substrate. Moreover, before occurrence of discharge between the wiring pattern and the counter electrode of the counter substrate, the charges are allowed to flow into the common voltage wiring through the electrostatic protection element.

### BRIEF DESCRIPTION OF THE DRAWINGS

These and other objects and advantages and further description of the invention will be more apparent to those skilled in the art by reference to the description, taken in connection with the accompanying drawings, in which:

FIG. 1A is a partial plan view showing a liquid crystal display device according to a first exemplary embodiment of the present invention, and FIG. 1B is a cross-sectional view along the line I-I in FIG. 1A.

FIGS. 2A and 2B are plan views showing structures of electrostatic protection element disposed in a peripheral region shown in FIG. 1A.

FIG. 3A is a partial plan view showing a liquid crystal display device according to a second exemplary embodiment of the present invention, and FIG. 3B is a cross-sectional view along the line II-II in FIG. 3A.

FIGS. 4A and 4B are plan views showing structures of electrostatic protection element disposed in a peripheral region shown in FIG. 3A.

FIG. 5A is a plan view showing the case where a scanning line drive circuit is formed by use of drive ICs mounted in a COG form in the liquid crystal display device of the first exemplary embodiment, and FIG. 5B is a cross-sectional view along the line III-III in FIG. 5A.

FIG. 6A is a plan view showing the case where a data line drive circuit is formed by use of drive ICs mounted in a COF form in the liquid crystal display device of the second exemplary embodiment, FIG. 6B is a plan view showing the COF member used in FIG. 6A, and FIG. 6C is a cross-sectional view along the line IV-IV in FIG. 6A.

### DETAILED DESCRIPTION OF THE PREFERRED EMBODIMENTS

First, with reference to the drawings, description will be given of a liquid crystal display device according to a first exemplary embodiment of the present invention. In this embodiment, the description will be given of the case where a protective transistor, particularly, a thin film transistor is used as electrostatic protection element.

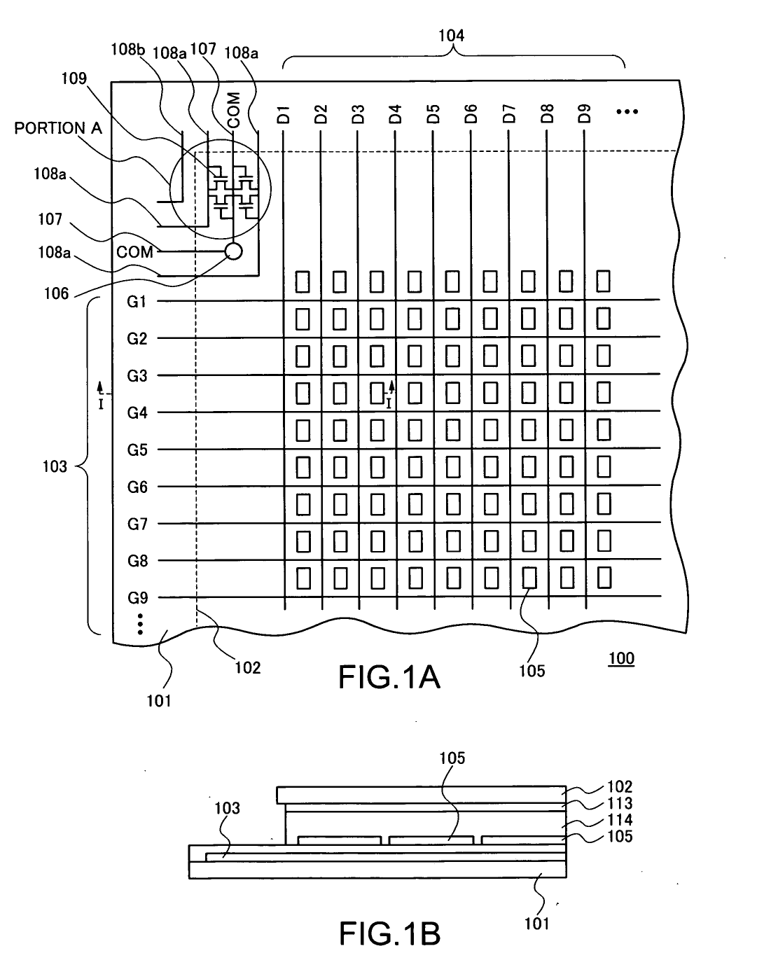

As shown in FIGS. 1A and 1B, a liquid crystal display device 100 of this embodiment is a liquid crystal display device having a liquid crystal layer 114 sandwiched between an active matrix substrate 101 having a plurality of pixel electrodes 105 formed thereon and a counter substrate 102 having a counter electrode 113 formed thereon. On the active matrix substrate 101, a plurality of scanning lines 103 (G1 to G9 . . . ) and a plurality of data lines 104 (D1 to D9 . . . ) are disposed so as to cross each other. Furthermore, in regions surrounded by the plurality of scanning lines 103 and the plurality of data lines 104, the plurality of pixel electrodes 105 are arranged, respectively. The scanning lines 103 and the data lines 104 are connected to the pixel electrodes 105 through switching transistors.

Furthermore, in a portion A of a peripheral region of the active matrix substrate 101, a wiring pattern is disposed for a drive IC mounted in a COG form or a COF form. The wiring pattern is one of a control signal wiring and a power supply wiring for the drive IC. The wiring pattern includes a plurality of wirings 108a and 108b. In addition, in the peripheral region, a transfer pad 106 is provided, which applies a common potential to the counter electrode 113 of the counter substrate 102. Moreover, a common voltage wiring 107 is provided and connected to the transfer pad 106. The plurality of wirings 108a and 108b and the common voltage wiring 107 are disposed parallel to each other. Furthermore, between each of the plurality of wirings 108a and the common voltage wiring 107, a protective transistor 109 is connected, as an example of electrostatic protection element. The protective transistor 109 has a configuration in which a source or a drain electrode and a gate electrode are connected in common. The protective transistors 109 are respectively connected in a forward-biased direction and in a reverse-biased direction between the plurality of wirings 108a and the common voltage wiring 107. The transistors 109 serve as a diode between the wirings 108a and the common voltage wiring 107.

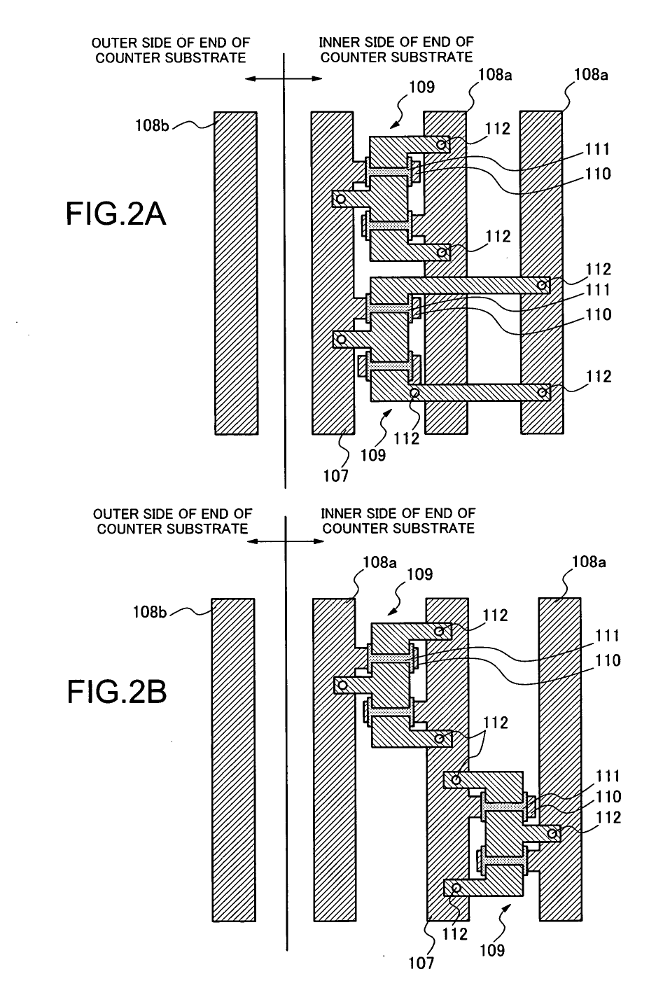

Next, with reference to FIGS. 2A and 2B, description will be given of a layout around the protective transistors in the portion A shown in FIG. 1A. FIG. 2A shows the case where wiring patterns to be protected includes the plurality of wirings 108a arranged substantially parallel to each other on one side of the common voltage wiring 107 and the protective transistors are provided between the common voltage wiring 107 and the plurality of wirings 108a, respectively. A pair of protective transistors 109 are provided between the common voltage wiring 107 and the wirings 108a. Either a source electrode or a drain electrode of the transistor 109 is connected in common with a gate electrode of each transistor 109. The pair of protective transistors 109 are provided in forward-biased and reverse-biased directions. A straight line between the common voltage wiring 107 and the wiring 108b represents an outer perimeter line of the counter substrate 102. A right side of the straight line in FIG. 2A is a region facing the counter substrate 102. Accordingly, the common voltage wiring 107 and the wirings 108a face the counter electrode 113 of the counter substrate 102. As described above, for the wirings 108a facing the counter electrode 113 of the counter substrate 102, the protective transistors 109 are connected between the wirings 108a and the common voltage wiring 107. Meanwhile, the left of the straight line in FIG. 2A is a region where the counter substrate 102 does not exist. No protective transistor is connected to the wiring 108b disposed in the region described above.

FIG. 2B shows the case where a wiring pattern to be protected includes a plurality of wirings arranged substantially parallel to each other on both sides of the common voltage wiring 107 and protective transistors 109 are provided between the common voltage wiring 107 and the plurality of wirings, respectively. Here, between the common voltage wiring 107 and the wirings 108a, a pair of protective transistors 109, in each of which a source or a drain electrode and a gate electrode are connected in common, are provided in the forward-biased and reverse-biased directions. A straight line between the wirings 108a and 108b represents an outer perimeter line of the counter substrate 102. A right side of the straight line in FIG. 2B is a region facing the counter substrate 102. Accordingly, the common voltage wiring 107 and the wirings 108a face the counter electrode 113 of the counter substrate 102. As described above, for the wirings 108a facing the counter electrode 113 of the counter substrate 102, the protective transistors 109 are connected between the wirings 108a and the common voltage wiring 107. Meanwhile, a left side of the straight line in FIG. 2B is a region where the counter substrate 102 does not exist. No protective transistor is connected to the wiring 108b disposed in the region described above.

Next, description will be given of operations of the protective transistor 109 according to this embodiment. In the case where electrostatic charges are accumulated in the wiring pattern to be protected during manufacturing steps, the protective transistor 109 is turned on when a potential difference between the common voltage wiring 107 and the voltage of wiring 108a gets higher than a threshold voltage V_{T} of the protective transistor 109. In other word, the protective transistor 109 is turned on when a potential difference between the common voltage wiring 107 and the wiring 108a gets higher than a forward voltage V_{F} of the diode made up of the transistor 109. Thus, the accumulated charges in the wiring pattern are released through the protective transistor 109. The protective transistors 109 are connected in the forward-biased and reverse-biased directions, respectively, between the common voltage wiring 107 and the wirings 108a. Thus, whether a potential of the wiring 108a gets higher or lower than that of the common voltage wiring 107, either of the protective transistors 109 operates to release the accumulated charges.

Furthermore, in manufacturing process, the protective transistors 109 as an example of the electrostatic protection element can be formed simultaneously with formation of switching transistors in a display region of the active matrix substrate 101. Firstly, in formation process of gate electrodes of the switching transistors in the display region, the gate electrodes 110 of the protective transistors 109 are formed. Then, in formation process of semiconductor films of the switching transistors in the display region on a gate insulating film, semiconductor films 111 of the protective transistors 109 are formed. Providing contact holes for the scanning lines in the gate insulating film, contact holes 112 for the common voltage wiring 107 and the wirings 108a are provided. Consequently, in formation process of source and drain electrodes of the switching transistors, source and drain electrodes of the protective transistors and wirings for connecting the electrodes to the common voltage wiring 107 and the wirings 108a are formed. As described above, the protective transistors 109 for the wiring pattern can be formed in the active matrix substrate 101 processes without additional manufacturing steps.

Next, with reference to the drawings, description will be given of a liquid crystal display device according to a second exemplary embodiment of the present invention. In this embodiment, the description will be given of the case where a high-resistance element is used as electrostatic protection element.

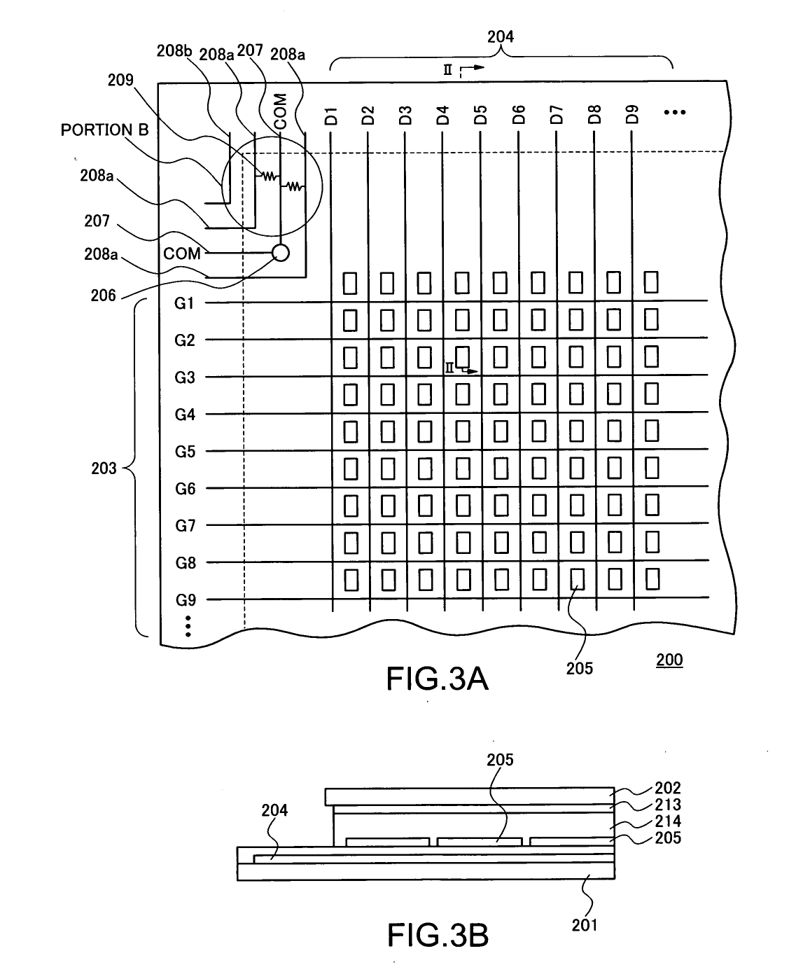

As shown in FIGS. 3A and 3B, a liquid crystal display device 200 has a liquid crystal layer 214 sandwiched between an active matrix substrate 201 having a plurality of pixel electrodes 205 formed thereon and a counter substrate 202 having a counter electrode 213 formed thereon. On the active matrix substrate 201, a plurality of scanning lines 203 (G1 to G9 . . . ) and a plurality of data lines 204 (D1 to D9 . . . ) are disposed so as to cross each other. Furthermore, in crossover regions surrounded by the plurality of scanning lines 203 and the plurality of data lines 204, the plurality of pixel electrodes 205 are arranged, respectively. The scanning lines 203 and the data lines 204 are connected to the pixel electrodes 205 through switching transistors.

Furthermore, in a portion B of a peripheral region of the active matrix substrate 201, wiring patterns are disposed for a drive IC mounted in a COG form or a COF form. The wiring patterns are a control signal wiring and a power supply wiring for the drive IC. The wiring pattern includes a plurality of wirings 208a and 208b. In addition, in the peripheral region, a transfer pad 206 is provided, which applies a common potential to the counter electrode 213 of the counter substrate 202. Moreover, a common voltage wiring 207 is provided, which is connected to the transfer pad 206. The plurality of wirings 208a and 208b and the common voltage wiring 207 are disposed parallel to each other. Furthermore, between each of the plurality of wirings 208a and the common voltage wiring 207, a high-resistance element is connected as an example of electrostatic protection element. The high-resistance element is formed of a high-resistance semiconductor film.

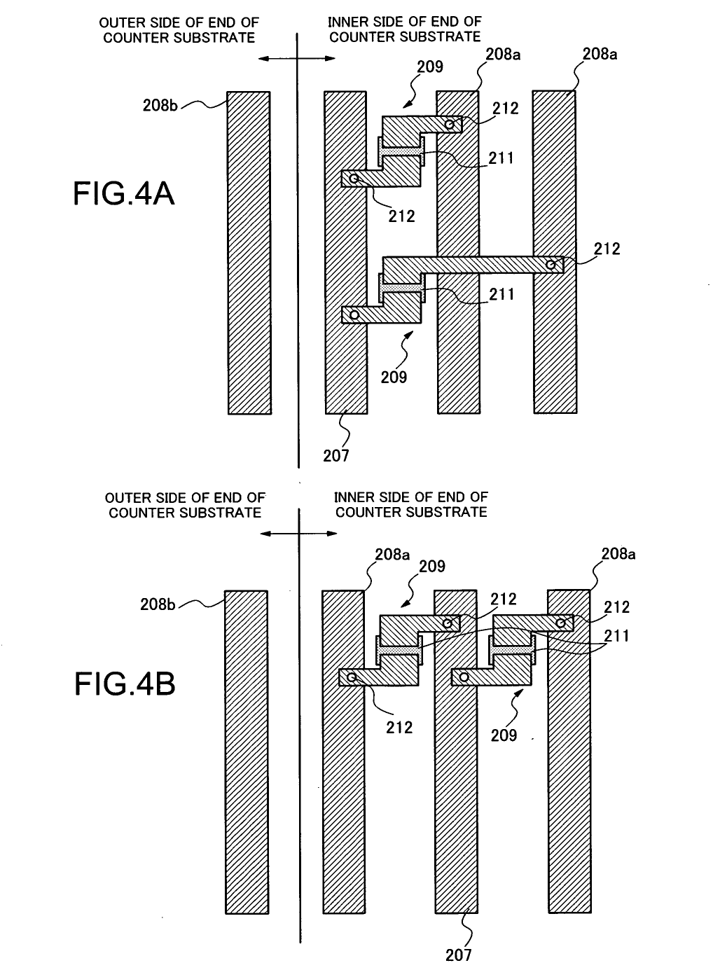

Next, with reference to FIGS. 4A and 4B, description will be given of a layout in the peripheral of the high-resistance elements in the portion B shown in FIG. 3A. FIG. 4A shows the case where a wiring pattern to be protected includes the plurality of wirings 208a arranged substantially parallel to each other on one side of the common voltage wiring 207 and the high-resistance elements are provided between the common voltage wiring 207 and the plurality of wirings 208a, respectively. A straight line between the common voltage wiring 207 and the wiring 208b represents an outer perimeter line of the counter substrate 202. A right side of the straight line in FIG. 4A is a region facing the counter substrate 202. Accordingly, the common voltage wiring 207 and the wirings 208a face the counter electrode 213 of the counter substrate 202. As described above, for the wirings 208a facing the counter electrode 213 of the counter substrate 202, high-resistance elements 209 are connected between the wirings 208a and the common voltage wiring 207. Meanwhile, a left side of the straight line in FIG. 4A is a region where the counter substrate 202 does not exist. No high-resistance element is connected to the wiring 208b disposed in the region described above.

FIG. 4B shows the case where a wiring pattern to be protected includes a plurality of wirings arranged substantially parallel to each other on both sides of the common voltage wiring 207 and high-resistance elements are provided between the common voltage wiring 207 and the plurality of wirings, respectively. Here, between the common voltage wiring 207 and the wirings 208a, high-resistance elements 209 are also provided. A straight line between the wirings 208a and 208b represents an outer perimeter line of the counter substrate 202. A right side of the straight line in FIG. 4B is a region facing the counter substrate 202. Accordingly, the common voltage wiring 207 and the wirings 208a face the counter electrode 213 of the counter substrate 202. As described above, for the wirings 208a facing the counter electrode 213 of the counter substrate 202, the high-resistance elements 209 are connected between the wirings 208a and the common voltage wiring 207. Meanwhile, a left side of the straight line in FIG. 4B is a region where the counter substrate 202 does not exist. No high-resistance element is connected to the wiring 208b disposed in the region described above.

According to this embodiment, electrostatic breakdown can be prevented by use of a simple configuration, compared with the case of using the protective transistors 109 of the first exemplary embodiment. Since the configuration is simple, the high-resistance elements are easily laid out also in a region where a number of wirings are disposed. Moreover, since no gate electrodes such as those of the protective transistors are required, the high-resistance elements can be disposed without being limited to the region adjacent to the common voltage wiring. Thus, there is an advantage that a degree of design flexibility is high.

Furthermore, the high-resistance elements as an example of the electrostatic protection element can be formed simultaneously in formation process of the switching transistors in the display region of the active matrix substrate. Specifically, in formation process of semiconductor films of the switching transistors in the display region on a gate insulating film, semiconductor films 211 of the high-resistance elements are formed. Moreover, in providing contact holes process for the scanning lines in the gate insulating film, contact holes 212 for the common voltage wiring 207 and the wirings 208a are provided. Furthermore, in formation process of source and drain electrodes of the switching transistors, wirings for connecting respective ends of the high-resistance elements to the common voltage wiring 207 and the wirings 208a are formed. As described above, the high-resistance elements 209 for the wiring pattern can be formed in the active matrix substrate 201 processes without additional manufacturing steps.

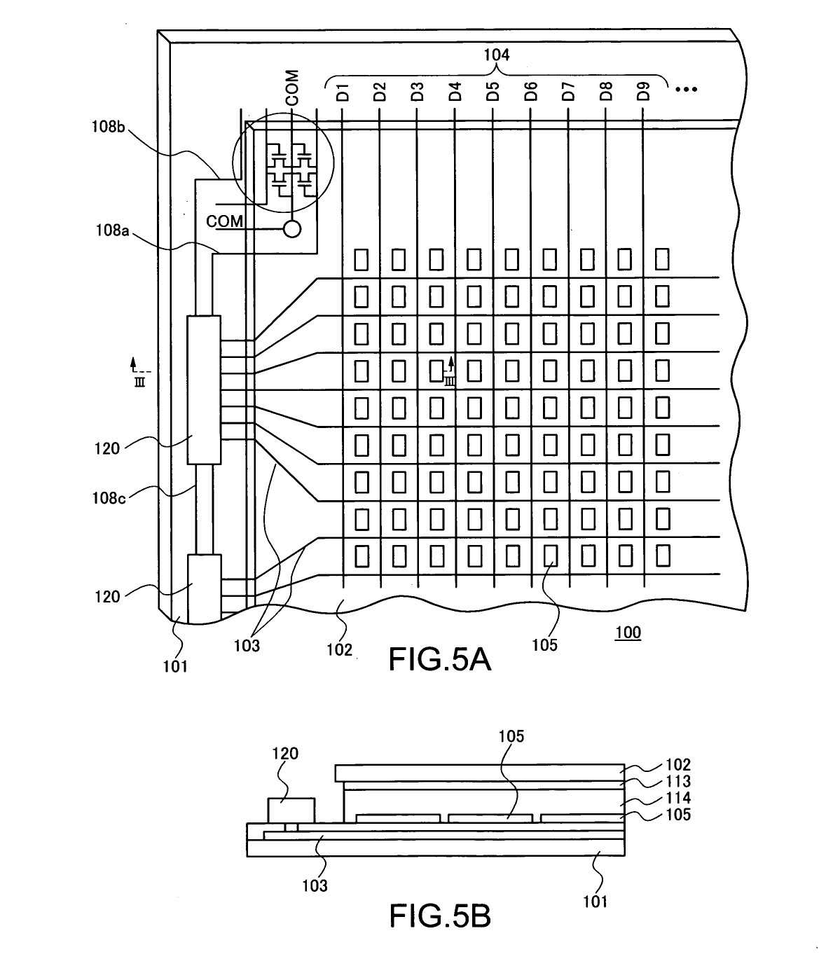

With reference to FIGS. 5A and 5B, description will be given of an example of the case where a scanning line drive circuit is formed by use of drive ICs mounted in the COG form in the liquid crystal display device 100 of the first exemplary embodiment described above. As shown in FIG. 5B, the liquid crystal display device 100 has a liquid crystal layer 114 sandwiched between the active matrix substrate 101 having the plurality of pixel electrodes 105 formed thereon and the counter substrate 102 having a counter electrode 113 formed thereon. Above the plurality of scanning lines 103, the plurality of data lines 104 are formed with a gate insulating film interposed therebetween. However, the data lines are not shown here. As shown in FIG. 5A, in the peripheral region of the active matrix substrate 101, a plurality of scanning line drive ICs 120 are mounted. Each of the scanning line drive ICs 120 is connected to the plurality of scanning lines 103 and outputs an ON voltage for turning on the switching transistors. Furthermore, in the peripheral region of the active matrix substrate 101, a plurality of wirings 108c for electrically connecting the plurality of scanning line drive ICs 120 to each other are formed. The wirings 108c described above are simultaneously formed in the step of forming the wirings 108a and 108b. The scanning line drive circuit sequentially supplies the ON voltage for turning on the switching transistors to the plurality of scanning lines 103, in synchronization with a vertical synchronizing signal of display data supplied to the liquid crystal display device 100. An operating voltage for operations, a ground voltage, a shift clock signal for supplying a write signal to the plurality of scanning lines 103, and the like are supplied to the scanning line drive ICs 120. The plurality of wirings 108c are power supply wirings, ground wirings and control signal wirings.

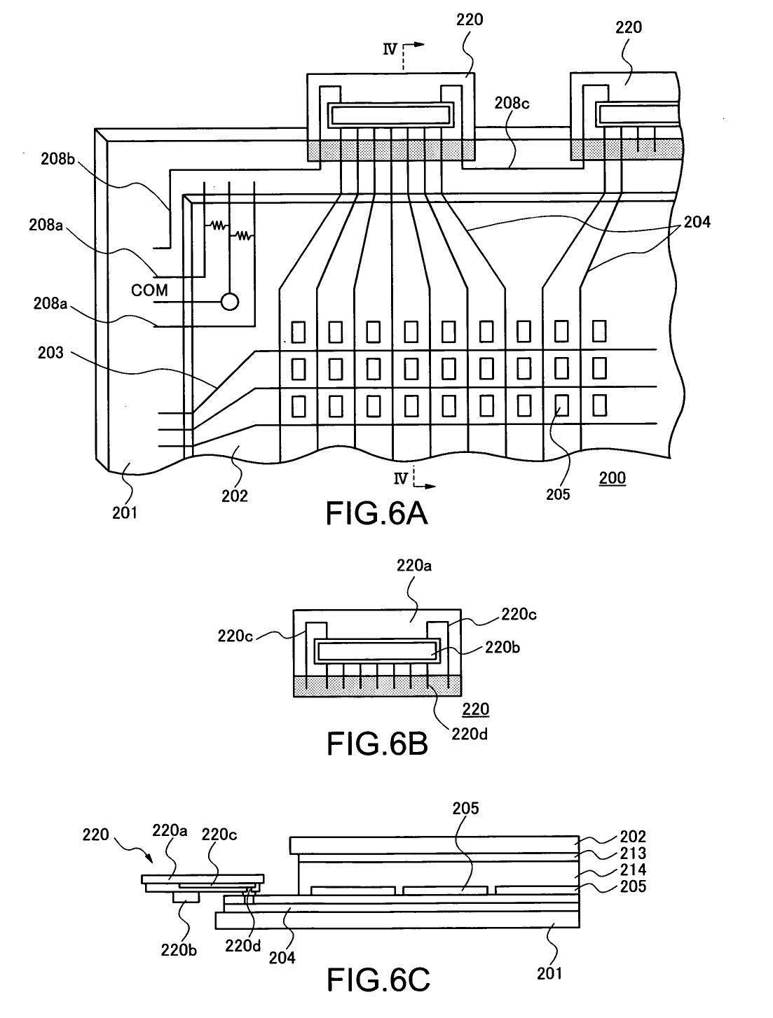

With reference to FIGS. 6A to 6C, description will be given of an example of the case where a data line drive circuit is formed by use of drive ICs mounted in the COF form in the liquid crystal display device 200 of the second exemplary embodiment described above. As shown in FIG. 6C, the liquid crystal display device 200 has a liquid crystal layer 214 sandwiched between the active matrix substrate 201 having the plurality of pixel electrodes 205 formed thereon and the counter substrate 202 having a counter electrode 213 formed thereon. Between the plurality of data lines 204 and the active matrix substrate 201, the plurality of scanning lines 203 and a gate insulating film are formed, which are not shown in FIG. 6C. In the peripheral region of the active matrix substrate 201, a plurality of COF members 220 are pressure-bonded and connected. As shown in FIG. 6B, each of the COF members 220 is obtained by mounting a data line drive IC 220b on a flexible substrate 220a having a plurality of wirings formed thereon. Moreover, the COF member 220 has wirings 220c and a plurality of output terminals 220d arranged on one side of the flexible substrate 220a. The data line drive IC 220b is connected to the plurality of data lines 204 through the output terminals 220d and outputs a write voltage to pixels according to display data. Furthermore, in the peripheral region of the active matrix substrate 201, wirings 208c for electrically connecting the plurality of data line drive ICs 220b to each other are formed. The wirings 208c described above are simultaneously formed in the step of forming the wirings 208a and 208b. The data line drive circuit supplies, to the plurality of data lines 204, a write signal according to display data to be written into each pixel, in synchronization with a horizontal synchronizing signal of display data supplied to the liquid crystal display device 200. An operating voltage for operations, a ground voltage, a shift clock signal, and the like are supplied to the data line drive ICs 220b. The wirings 208c are power supply wirings, ground wirings or control signal wirings. The signal or voltage supplied to the wiring 208b is supplied to the adjacent COF member 220 through one of the COF members 220 connected to the active matrix substrate 201 and the wirings 208c. Specifically, the signal or voltage supplied to the wiring 208b is supplied to the data line drive ICs 220b mounted on the plurality of COF members 220 through the wirings 220c formed in the COF members 220 and the wirings 208c formed on the active matrix substrate 201.

Especially, ESD tends to occur in following procedures, 1) putting a polarizing sheet on a liquid crystal panel in assembly process and 2) an operator handling a liquid crystal panel in storage. Meanwhile, in the liquid crystal display device of the present invention, the electrostatic protection element disposed in the peripheral region having the configuration described above can suppress electrostatic breakdown of the control signal wirings and the power supply wirings for the drive ICs mounted in the COG form or the COF form.

Although the embodiments have been described above, the present invention is not limited thereto but various changes and applications are possible. As the electrostatic protection element, not only the thin film transistor having the structure of the embodiment described above but also a thin film transistor having a different structure can be used.

As a utilization example of the present invention, applications to a compact and thin liquid crystal display device and a narrow-bezel liquid crystal display device are conceivable.

Although preferred embodiments of the invention has been described with reference to the drawings, it will be obvious to those skilled in the art that various changes or modifications may be made without departing from the true scope of the invention.

What is claimed is:

1. A liquid crystal display device, comprising: an active matrix substrate having a plurality of pixel electrodes formed thereon; a counter electrode formed thereon; and a liquid crystal layer is sandwiched between the active matrix substrate and the counter substrate,
the active matrix substrate comprising a display region, in which the plurality of pixel electrodes are formed, and a peripheral region therearound,
a transfer pad which applies a common potential to the counter electrode of the counter substrate,
a common voltage wiring connected to the transfer pad,
a wiring pattern disposed in a vicinity of the common voltage wiring, and
an electrostatic protection element connected between the common voltage wiring and the wiring pattern.

2. The liquid crystal display device according to claim 1, wherein the electrostatic protection element is a transistor.

3. The liquid crystal display device according to claim 2, wherein the transistor is a thin film transistor in which one of a source electrode and a drain electrode is connected in common with a gate electrode.

4. The liquid crystal display device according to claim 1, wherein the electrostatic protection element is a diode.

5. The liquid crystal display device according to claim 2, wherein the wiring pattern includes a plurality of wirings arranged substantially parallel to each other on one side of the common voltage wiring, and the transistors are provided, respectively, between the common voltage wiring and each of the plurality of wirings.

6. The liquid crystal display device according to claim 3, wherein the wiring pattern includes a plurality of wirings arranged substantially parallel to each other on both sides of the common voltage wiring, and the transistors are provided, respectively, between the common voltage wiring and each of the plurality of wirings.

7. The liquid crystal display device according to claim 2, wherein the wiring pattern includes a first wiring facing the counter electrode of the counter substrate and a second wiring outside an area covered by the counter substrate, the first and second wirings being arranged substantially parallel to each other, the transistor is provided between the first wiring and the common voltage wiring, and no electrostatic protection element is provided between the second wiring and the common voltage wiring.

8. The liquid crystal display device according to claim 7, wherein the first wiring and the second wiring are connected with a driver IC mounted in a COG form of COF form in the peripheral region of the active matrix substrate.

9. The liquid crystal display device according to claim 1, wherein the electrostatic protection element is a high-resistance element.

10. The liquid crystal display device according to claim 9, wherein the high-resistance element is formed of a semiconductor film.

11. The liquid crystal display device according to claim 10, wherein the semiconductor film is a resistor configured to bleed off accumulated electrostatic charges from the wiring pattern.

12. The liquid crystal display device according to claim 9, wherein the wiring pattern includes a plurality of wirings arranged substantially parallel to each other on one side of the common voltage wiring, and the high-resistance elements are provided, respectively, between the common voltage wiring and the plurality of wirings.

13. The liquid crystal display device according to claim 9, wherein the wiring pattern includes a plurality of wirings arranged substantially parallel to each other on both sides of the common voltage wiring, and the a high-resistance elements are provided, respectively, between the common voltage wiring and the plurality of wirings.

14. The liquid crystal display device according to claim 9, wherein the wiring pattern includes a first wiring facing the counter electrode of the counter substrate and a second wiring outside an area covered by the counter substrate, the first and second wirings being arranged substantially parallel to each other, the high-resistance element is provided between the first wiring and the common voltage wiring, and no electrostatic protection element is provided between the second wiring and the common voltage wiring.

15. The liquid crystal display device according to claim 14, wherein the first wiring and the second wiring are connected with a driver IC mounted in a COG form of COF form in the peripheral region of the active matrix substrate.

16. The liquid crystal display device according to claim 1, wherein the wiring pattern is one of a control signal wiring and a power supply wiring for a drive IC mounted in a COG form in the peripheral region of the active matrix substrate.

17. The liquid crystal display device according to claim 1, wherein the wiring pattern is one of a control signal wiring and a power supply wiring for a drive IC mounted in a COF form in the peripheral region of the active matrix substrate.

18. The liquid crystal display device according to claim 1, further comprising:
a drive IC mounted in a COG form or a COF form in the peripheral region of the active matrix substrate,
the wiring pattern connected to the drive IC, and
the wiring pattern being one of a control signal wiring and a power supply wiring for a drive IC.

19. The liquid crystal display device according to claim 16, wherein the electrostatic protection element is a transistor.

20. The liquid crystal display device according to claim 16, wherein the electrostatic protection element is a diode.

21. The liquid crystal display device according to claim 16, wherein the electrostatic protection element is a resistor.
